(19) United States
(12) Patent Application Publication
(10) Pub. No.: US 2010/0177393 A1
(43) Pub. Date: Jul. 15, 2010

(54) Reflective structure, display apparatus including the reflective structure, and method of manufacturing the reflective structure and display apparatus

(75) Inventors: Hong-Seok Lee, Seongnam-si (KR); Yong-hee Lee, Daejeon (KR); Jung-hoon Shin, Daejeon (KR); Sung-yong Kang, Daejeon (KR); Seong-hwan Chae, Daejeon (KR)

Correspondence Address: HARNESS, DICKEY & PIERCE, P.L.C., P.O. BOX 8910, RESTON, VA, 20195, US

(73) Assignees: Samsung Electronics Co., Ltd.; Korea Advanced Institute of Science and Technology

(21) Appl. No.: 12/654,713

(22) Filed: Dec. 30, 2009

(30) Foreign Application Priority Data
Jan. 13, 2009 (KR) 10-2009-0002730

(51) Int. Cl. G02B 5/28; B05D 1/36; B05D 3/12; B29D 11/00

(52) U.S. Cl. 359/584; 427/203; 427/299; 216/24

(57) ABSTRACT

Example embodiments relate to a reflective structure, a display apparatus including the reflective structure, and a method of manufacturing the reflective structure and the display apparatus. A reflective structure according to example embodiments may include a plurality of nanoparticles of non-uniform size, which are arranged on a substrate, or an uneven element having a surface contour that resembles a plurality of nanoparticles; and a reflective layer covering the plurality of nanoparticles or the uneven element. The reflective layer may have a random/variable height.

### CROSS-REFERENCE TO RELATED APPLICATIONS

This application claims priority under 35 U.S.C. §119 to Korean Patent Application No. 10-2009-0002730, filed on Jan. 13, 2009 with the Korean Intellectual Property Office, the entire disclosure of which is incorporated herein by reference.

### BACKGROUND

1. Field

Example embodiments relate to a reflective structure, a display apparatus including the reflective structure, and a method of manufacturing the reflective structure and display apparatus.

2. Description of the Related Art

Pigments are conventionally used to realize colors via the absorption of light. However, conventional color realization technology using light absorption has efficiency problems as well as problems controlling chromaticity. To address such problems, color realization technology using reflection and interference of light, which is referred to as structural color technology, has been proposed. In structural color technology, because efficiency is determined according to a reflectance of a reflector, it is possible to realize colors more efficiently. Also, because chromaticity is determined according to the wavelength of light that is reflected, it may be easier to control chromaticity. However, in structural color technology, a color may be differently realized depending on an angle of light incident on the reflector and a viewing angle, and multi-coloration may occur, because the color may be relatively bright or dim at a specific angle due to constructive and destructive interference of diffracted light.

### SUMMARY

Example embodiments include an omni-directional reflective structure (which does not result in a color change because of the viewing angle) and a method of manufacturing the omni-directional reflective structure. Example embodiments also include a display apparatus including the reflective structure and a method of manufacturing the display apparatus.

A reflective structure according to example embodiments may include an understructure having a first uneven surface, the understructure being a plurality of nanoparticles of non-uniform size on a substrate or being a sublayer having a non-uniform surface that resembles a plurality of nanoparticles or that is equivalent to surfaces of the plurality of nanoparticles; and a reflective layer on the understructure, the reflective layer having a second uneven surface.

The reflective layer may have a structure in which a first layer and a second layer are alternately stacked. The first layer and the second layer may be different dielectric layers. One of the first layer and the second layer may be a dielectric layer, and the other one of the first layer and the second layer may be a non-dielectric layer. The non-dielectric layer may be a metal layer. The metal layer may include a transition metal.

A reflective structure according to example embodiments may also include an understructure having a first uneven surface; and a reflective layer on the first uneven surface of the understructure, the reflective layer having a second uneven surface, and wherein the reflective layer includes at least one non-dielectric layer and at least one dielectric layer, the non-dielectric layer and the dielectric layer being alternately stacked.

A reflective structure according to example embodiments may also include a substrate having an uneven part which is arranged on a top surface of the substrate; and a reflective layer covering the uneven part, and having a random height and a structure in which a non-dielectric layer and a dielectric layer are alternately stacked. The non-dielectric layer may be a metal layer. The metal layer may include a transition metal.

A method of manufacturing a reflective structure according to example embodiments may include coating a substrate with a plurality of nanoparticles of non-uniform size; and forming a reflective layer on the plurality of nanoparticles, the reflective layer having an uneven surface that corresponds to a contour of the plurality of nanoparticles. The reflective layer may have a structure in which a first layer and a second layer are alternately stacked. The first layer and the second layer may be different dielectric layers. One of the first layer and the second layer may be a dielectric layer, and the other one of the first layer and the second layer may be a non-dielectric layer. The non-dielectric layer may be a metal layer. The metal layer may include a transition metal.

A method of manufacturing a reflective structure according to example embodiments may also include coating a supporting material with a plurality of nanoparticles of non-uniform size; forming a mold layer covering the plurality of nanoparticles; separating the mold layer from the supporting material to attain a master stamp having an under surface that corresponds to a contour of the plurality of nanoparticles; forming a first uneven surface on a substrate by imprinting the substrate with the master stamp; and forming a reflective layer covering the first uneven surface, the reflective layer having a second uneven surface that corresponds to a contour of the first uneven surface.

The reflective layer may have a structure in which a first layer and a second layer are alternately stacked. The first layer and the second layer may be different dielectric layers. One of the first layer and the second layer may be a dielectric layer, and the other one of the first layer and the second layer may be a non-dielectric layer. The non-dielectric layer may be a metal layer. The metal layer may include a transition metal.

A method of manufacturing a reflective structure according to example embodiments may also include coating a substrate with a plurality of first nanoparticles; etching the plurality of first nanoparticles and exposed portions of the substrate between the plurality of first nanoparticles to form an etched substrate having a first uneven surface; and forming a reflective layer on the etched substrate, the reflective layer having a second uneven surface that corresponds to a contour of the first uneven surface. The plurality of first nanoparticles may be of non-uniform size. Alternatively, the plurality of first nanoparticles may be of uniform size.

Forming the etched substrate having the first uneven surface may include initially etching the plurality of first nanoparticles to expose portions of the substrate between the plurality of first nanoparticles; and etching the exposed portions of the substrate. Alternatively, forming the etched substrate having the first uneven surface may include simultaneously etching the plurality of first nanoparticles and the exposed portions of the substrate between the plurality of first nanoparticles.

After forming the etched substrate having the first uneven surface, the method may further include removing the plurality of first nanoparticles. After the removing the plurality of first nanoparticles, the method may further include coating the substrate with a plurality of second nanoparticles; and etching the plurality of second nanoparticles and exposed portions of the substrate between the plurality of second nanoparticles.

The reflective layer may have a structure in which a first layer and a second layer are alternately stacked. The first layer and the second layer may be different dielectric layers. One of the first layer and the second layer may be a dielectric layer, and the other one of the first layer and the second layer may be a non-dielectric layer. The non-dielectric layer may be a metal layer. The metal layer may include a transition metal.

A display apparatus may include a reflective structure according to example embodiments. The display apparatus may be a liquid crystal display (LCD). The reflective layer of the reflective structure may have a structure in which a first layer and a second layer are alternately stacked. The first layer and the second layer may be different dielectric layers. One of the first layer and the second layer may be a dielectric layer, and the other one of the first layer and the second layer may be a non-dielectric layer. The non-dielectric layer may be a metal layer. The metal layer may include a transition metal.

### BRIEF DESCRIPTION OF THE DRAWINGS

The above and/or other aspects of example embodiments may become more readily appreciated when the following detailed description is read in conjunction with the accompanying drawings of which:

FIG. 1 is a cross-sectional view of a reflective structure according to example embodiments;

FIG. 2 is a scanning electron microscope (SEM) image of a cross-section of a reflective structure having the structure of FIG. 1;

FIG. 3 is a cross-sectional view of another reflective structure according to example embodiments;

FIGS. 4 through 7 are graphs illustrating changes in a reflection spectrum based on various thicknesses and types of dielectric layers used in a reflective layer according to example embodiments;

FIGS. 8A and 8B are cross-sectional views of a method of manufacturing a reflective structure according to example embodiments;

FIGS. 9A through 9G are cross-sectional views of another method of manufacturing a reflective structure according to example embodiments;

FIGS. 10A and 10B are cross-sectional views of another method of manufacturing a reflective structure according to example embodiments;

FIGS. 11A through 11E are cross-sectional views of another method of manufacturing a reflective structure according to example embodiments;

FIG. 12 is an SEM image of a substrate/uneven layer formed using a method of manufacturing a reflective structure according to example embodiments; and

FIG. 13 is a cross-sectional view of a liquid crystal display (LCD) to which a reflective structure according to example embodiments is applied.

### DETAILED DESCRIPTION

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items.

It will be understood that when an element or layer is referred to as being “formed on,” another element or layer, it can be directly or indirectly formed on the other element or layer. That is, for example, intervening elements or layers may be present. In contrast, when an element or layer is referred to as being “directly formed on” another element, there are no intervening elements or layers present. Other words used to describe the relationship between elements or layers should be interpreted in a like fashion (e.g., “between,” versus “directly between,” “adjacent,” versus “directly adjacent,” etc.).

Spatially relative terms, e.g., “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art. It will be further understood that terms, including those defined in commonly used dictionaries, should be interpreted as having a meaning that is consistent with their meaning in the context of the relevant art and will not be interpreted in an idealized or overly formal sense unless expressly so defined herein.

Hereinafter, a reflective structure, a display apparatus including the reflective structure, and a method of manufacturing the reflective structure and the display apparatus according to example embodiments will be described with reference to the accompanying drawings. In this regard, example embodiments may have different forms and should not be construed as being limited to the descriptions set forth herein. In the drawings, the thicknesses and/or positions of various layers and/or regions may have been exaggerated for clarity. Like reference numerals in the drawings denote like elements.

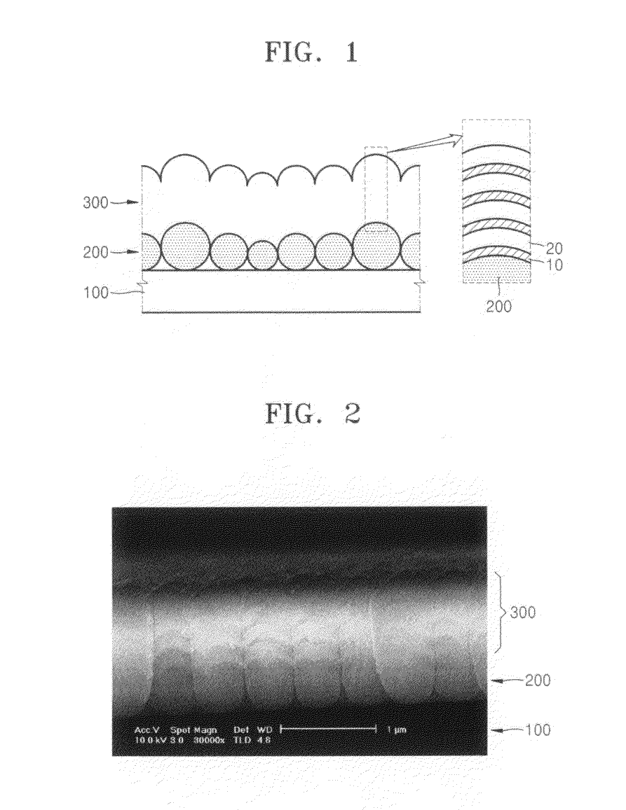

FIG. 1 is a cross-sectional view of a reflective structure according to example embodiments. Referring to FIG. 1, a plurality of nanoparticles 200 having non-uniform sizes may be arranged on a substrate 100. The substrate 100 may be any substrate that can be used in a semiconductor process. For example, a material forming the substrate 100 may be a semiconductor (e.g., silicon) or an insulating material (e.g., silicon oxide). Also, the substrate 100 may be formed of a conductive material (e.g., indium-tin oxide (ITO) or metal). The substrate 100 may be transparent or opaque. The plurality of nanoparticles 200 may form a mono-layer but example embodiments are not limited thereto. A material forming the plurality of nanoparticles 200 may be a silicon oxide, polycrystalline silicon, and the like but example embodiments are not limited thereto and thus, the material may vary. The plurality of nanoparticles 200 may be in the range of several tens to several hundreds of nanometers in diameter. A reflective layer 300 may be formed on the plurality of nanoparticles 200. The reflective layer 300 may have a multi-layered structure in which a first layer 10 and a second layer 20 are alternately and repeatedly stacked. The reflective layer 300 may be formed to have random heights due to the plurality of nanoparticles 200. That is, the reflective layer 300 may be conformed with shapes of top surfaces of the plurality of nanoparticles 200. Hereinafter, the reflective layer 300 will be described in further detail.

The first layer 10 and the second layer 20 may have different refractive indexes. Because the refractive indexes of the first and second layers 10 and 20 are different from each other, reflection of light may occur at an interface between the first layer 10 and the second layer 20. By adjusting materials and thicknesses of the first and second layers 10 and 20, a wavelength of the reflected light may vary. Thus, according to the materials and the thicknesses of the first and second layers 10 and 20, colors exhibited at the reflective layer 300 may vary.

One of the first and second layers 10 and 20 may be a non-dielectric layer, and the other one of the first and second layers 10 and 20 may be a dielectric layer. The non-dielectric layer may be a metal layer. For example, the first layer 10 may be the metal layer and the second layer 20 may be the dielectric layer. Thus, the reflective layer 300 may have a structure in which the metal layer and the dielectric layer are alternately stacked. In the case where the first layer 10 is the metal layer, the first layer 10 may be formed of a transition metal (e.g., Cr, Ni, Co, etc.). However, the first layer 10 may be formed of another metal along with the transition metal. When the first layer 10 is the metal layer, the first layer 10 may be formed to be relatively thin so that absorbance of light via the first layer 10 may be minimized. For example, the first layer 10 may be formed to have a thickness less than about 50 nm at the thicker portions, or less than about 20 nm at the thinner portions. In the case where the second layer 20 is the dielectric layer, the second layer 20 may be formed of SiO₂, CaF₂, LiF, MgF₂ or the like but a material forming the second layer 20 may vary. The second layer 20 may have an optical thickness corresponding to λ/2 (here, λ indicates a center wavelength of light to be reflected). When the second layer 20 has the optical thickness corresponding to λ/2, constructive interference of diffracted light may occur.

Alternatively, the first and second layers 10 and 20 may be formed as different dielectric layers. That is, the reflective layer 300 may have a structure in which a first dielectric layer and a second dielectric layer are alternately and repeatedly stacked. In this structure, reflection of light having a specific wavelength may also occur at an interface between the first layer 10 and the second layer 20.

In FIG. 1, because the reflective layer 300 has random/varying heights, an omni-directional reflection (which does not cause a color change due to a viewing angle) may be possible. If the first and second layers 10 and 20 are completely planar, reflected light may be bright or dim at a specific angle so that a color may change depending on the viewing angle or multi-coloration may occur. However, in FIG. 1, because the reflective layer 300 has random heights, the light may be reflected, diffracted, and/or diffused at various angle on various heights. Also, because the relatively small nanoparticles 200 are densely arranged, unit regions of the reflective layer 300 may also be densely arranged, wherein the unit regions have relatively small sizes and respectively correspond to the nanoparticles 200. Because the unit regions of the reflective layer 300 are densely arranged and have random heights, reflection, diffraction, and/or diffusion with respect to the light may occur from each of the unit regions. Furthermore, because top surfaces of the unit regions of the reflective layer 300 may be rounded or round-shaped, the light may be reflected at different angles. Therefore, the reflective structure according to FIG. 1 may be an omni-directional reflective structure which does not cause a color change due to the viewing angle.

In addition, in the case where the reflective layer 300 is formed to have a non-dielectric layer (e.g., a metal layer)-dielectric layer structure, the number of stacked layers for forming the reflective layer 300 may be reduced, compared to using a dielectric layer-dielectric layer structure. This is because a refractive index difference between the non-dielectric layer (e.g., metal layer) and the dielectric layer may be greater than a refractive index difference between the dielectric layer and the dielectric layer. For example, in the case where the reflective layer 300 is formed using the dielectric layer-dielectric layer structure, about 20 layers (10 pairs) may be need to be stacked to realize a color.

On the other hand, in the case where the non-dielectric layer (e.g., metal layer)-dielectric layer structure is used, about 6 layers (3 pairs) or more may be sufficient to realize the color. Accordingly, when the non-dielectric layer (e.g., metal layer)-dielectric layer structure is used, the manufacturing process may be simplified and the size of the reflective structure may be reduced. Also, in the case of the non-dielectric layer (e.g., metal layer)-dielectric layer structure, because a bandwidth of a reflection spectrum is smaller than that in the dielectric layer-dielectric layer structure, higher chromaticity may be realized with greater ease.

FIG. 2 is a scanning electron microscope (SEM) image of a cross-section of a reflective structure having the structure of FIG. 1. As shown in FIG. 2, a surface of a reflective layer 300 is uneven.

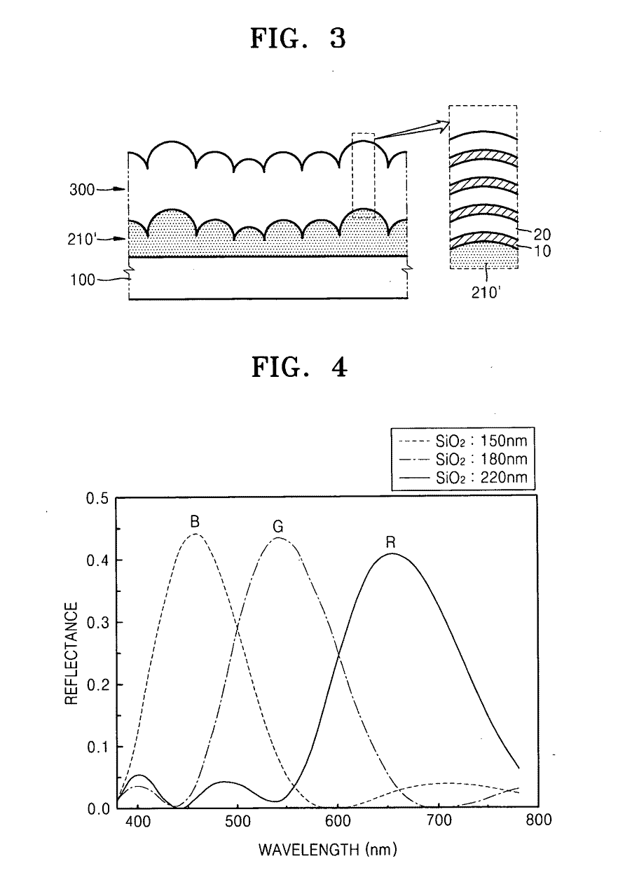

FIG. 3 is a cross-sectional view of another reflective structure according to example embodiments. The reflective structure of FIG. 3 is a variation of the reflective structure of FIG. 1. One difference between FIG. 1 and FIG. 3 is the uneven layer 210′ below the reflective layer 300 in FIG. 3.

Referring to FIG. 3, an uneven layer 210′ may be arranged on a substrate 100. A shape of a top surface of the uneven layer 210′ may be similar to that of the plurality of nanoparticles 200 of FIG. 1. That is, the uneven layer 210′ may have an unevenness which resembles the contour of the plurality of nanoparticles 200 of FIG. 1. The uneven layer 210′ may be formed using a nano-imprint method that uses a master stamp to which the unevenness of a plurality of nanoparticles 200 is transferred. This method will be described later. A reflective layer 300 may be arranged on the uneven layer 210′. A structure of the reflective layer 300 of FIG. 3 may be the same as that of the reflective layer 300 of FIG. 1.

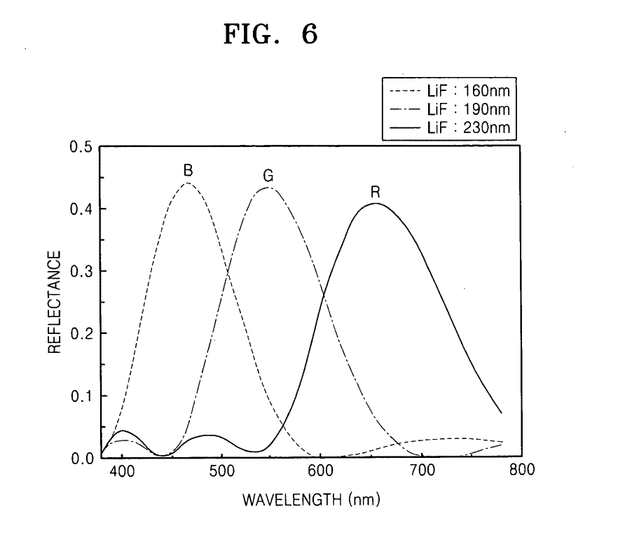

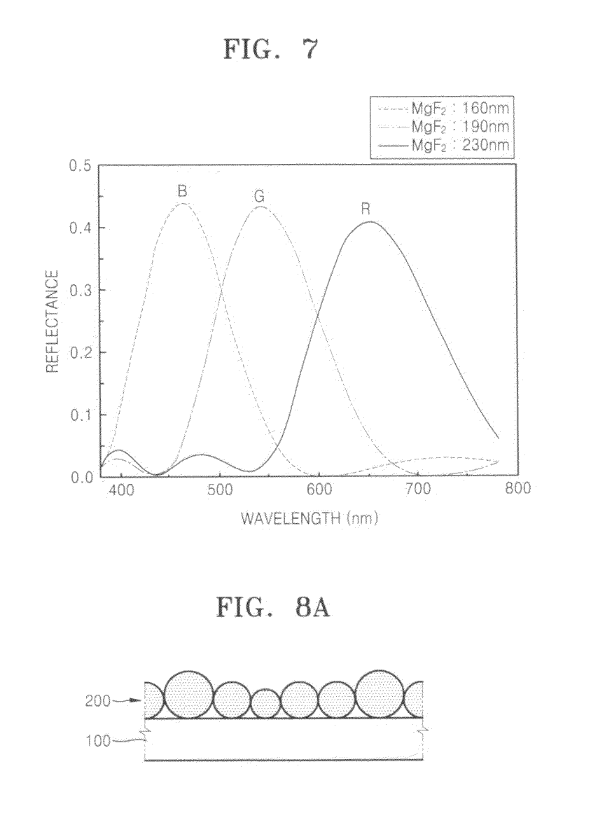

FIGS. 4 through 7 are graphs showing changes in a reflection spectrum based on various thicknesses and types of dielectric layers used in a reflective layer according to example embodiments. Results of FIGS. 4 through 7 are related to the reflective layer in which a metal layer and a dielectric layer are alternately and repeatedly stacked. The dielectric layers for forming the reflective layers of FIGS. 4 through 7 are respectively a SiO₂ layer, a CaF₂ layer, a LiF layer and an MgF₂ layer. Meanwhile, the metal layers for forming the reflective layers are all Cr layers (thickness 5 nm).

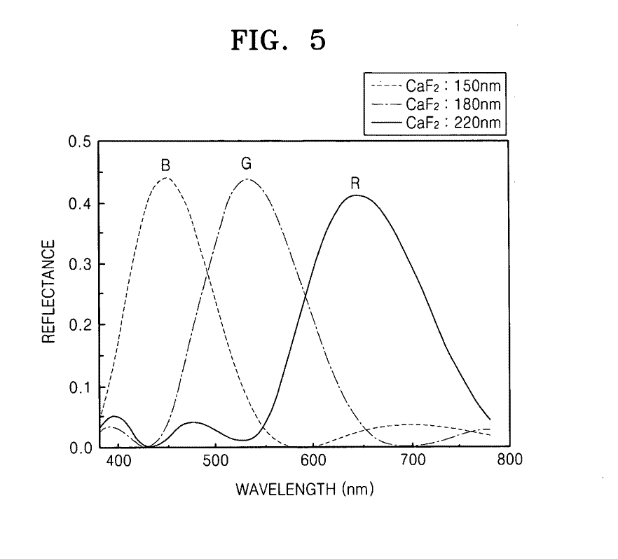

Referring to FIG. 4, spectrums of red (R), green (G), and blue (B) are obtained according to a thickness of the SiO₂ dielectric layer. Likewise, referring to FIGS. 5 through 7, spectrums of red (R), green (G), and blue (B) are obtained by adjusting the thicknesses of the CaF₂, LiF, and MgF₂ dielectric layers, respectively.

The reflective structure according to example embodiments may have a plurality of reflective layers for exhibiting different colors on a substrate. For example, first through third reflective layers may be formed in different regions of the substrate, and by varying thicknesses and/or materials of layers for forming the first through third reflective layers, the first through third reflective layers may be formed to reflect different colors (e.g., red, green, and blue).

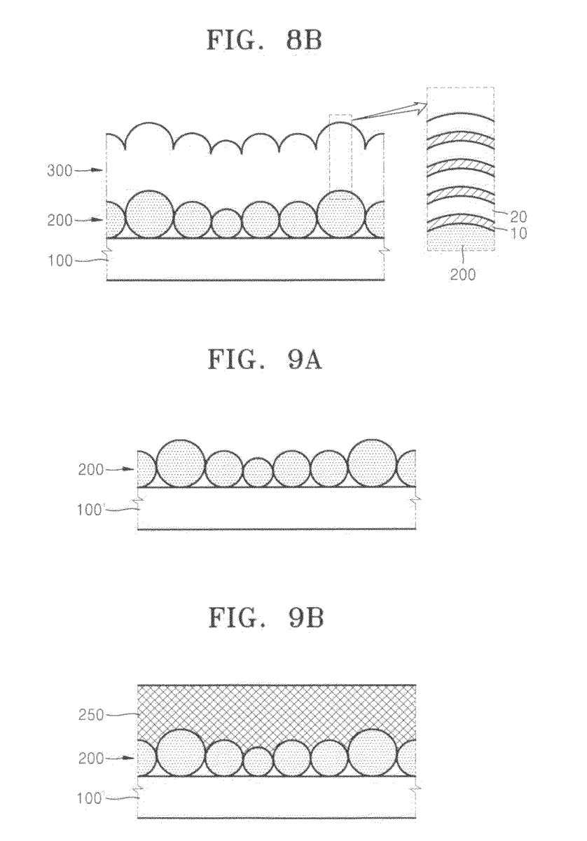

FIGS. 8A and 8B are cross-sectional views of a method of manufacturing a reflective structure according to example embodiments. Referring to FIG. 8A, a plurality of nanoparticles 200 having non-uniform sizes may be coated on a substrate 100. The substrate 100 of FIG. 8A may be the same as the substrate 100 of FIG. 1. The plurality of nanoparticles 200 may be formed using a spin coating method but the coating method is not limited thereto. The plurality of nanoparticles 200 may form a mono-layer but example embodiments are not limited thereto. A material forming the plurality of nanoparticles 200 may be a silicon oxide, polycrystalline silicon, and the like but the material may vary. The plurality of nanoparticles 200 may be in the range several tens to several hundreds of nanometers in diameter. The forming method, material, size, and other aspects which are related to the substrate 100 and the plurality of nanoparticles 200 may be the same in other methods to be described below.

Referring to FIG. 8B, a first layer 10 and a second layer 20 may be alternately and repeatedly stacked on the plurality of nanoparticles 200, thereby forming the reflective layer 300. The reflective layer 300 may be formed to be conformed with the shapes of the plurality of nanoparticles 200, thereby having random heights. Materials, thicknesses, and other aspects with respect to the first and second layers 10 and 20 may be the same as those described in relation to FIG. 1.

According to example embodiments, the reflective layer 300 having the random heights may be formed with relative ease using the plurality of nanoparticles 200. In contrast, to conventionally form an uneven surface on a substrate with an etching method that uses an e-beam, an e-beam lithography process has to be performed several times. Thus, this conventional procedure may increase the complexity and costs of the manufacturing process. On the other hand, the method according to example embodiments uses the plurality of nanoparticles 200 so that the reflective layer 300 having the random heights may be formed at a relatively low cost and in a relatively simple manner. Also, the method according example embodiments may be advantageous with respect to increasing the area of the reflective layer 300.

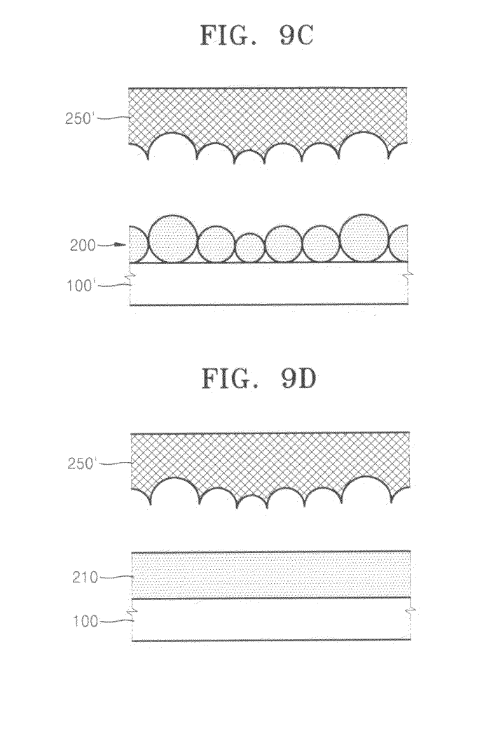

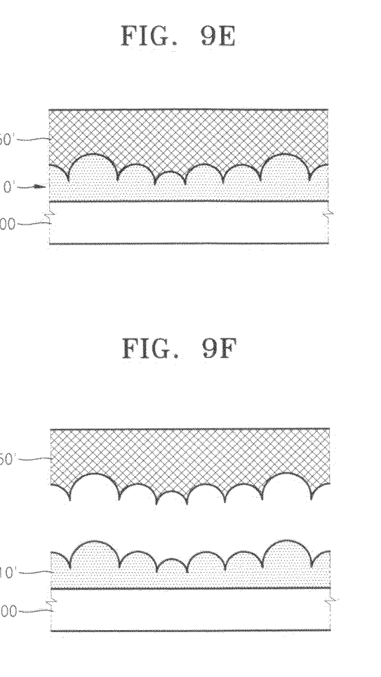

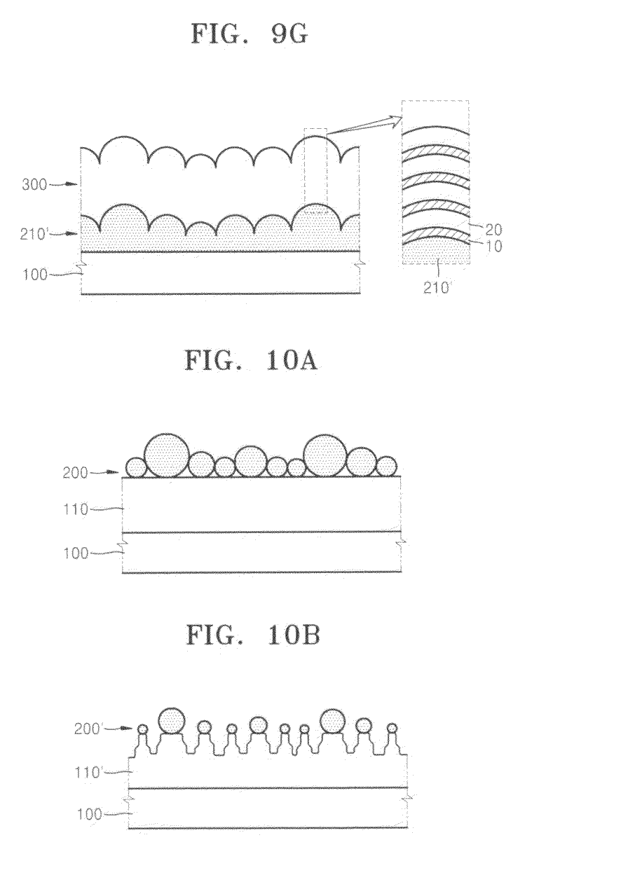

FIGS. 9A through 9G are cross-sectional views of another method of manufacturing a reflective structure according to example embodiments. The method of FIGS. 9A-9G uses a nano-imprint process. Referring to FIG. 9A, a plurality of nanoparticles 200 having non-uniform sizes may be coated on a supporting material 100′. The plurality of nanoparticles 200 may form a mono-layer but example embodiments are not limited thereto.

Referring to FIG. 9B, a mold layer 250 may be formed to cover the plurality of nanoparticles 200. The mold layer 250 may be formed as a resin layer (e.g., polydimethylsiloxane (PDMS), a ultra-violet (UV) curing agent, a thermal curing agent, and the like) but may also be formed of metal. In the case where the mold layer 250 is formed of metal, a plating method may be used.

Referring to FIG. 9C, the mold layer 250 is separated from the plurality of nanoparticles 200 and the supporting material 100′ to form a master stamp 250′. As shown in FIG. 9C, the unevenness of the plurality of nanoparticles 200 is transferred to the under surface of the master stamp 250′. Hereinafter, the separated mold layer 250 will be referred to as the master stamp 250′.

Referring to FIG. 9D, after preparing a substrate 100 on which a resin layer 210 is formed, the master stamp 250′ may be arranged above the resin layer 210. Here, the substrate 100 may be the same as the substrate 100 of FIG. 8A. The resin layer 210 may be substituted with another suitable material layer. Also, the resin layer 210 may be regarded as a substrate or a part of the substrate.

Referring to FIG. 9E, the resin layer 210 is imprinted using the master stamp 250′ so that the unevenness of the master stamp 250′ may be transferred to the resin layer 210 to form an uneven layer 210′.

Referring to FIG. 9F, the master stamp 250′ may be separated from the uneven layer 210′. The master stamp 250′ may be repeatedly used as deemed appropriate. Thus, the nano-imprint process may be advantageous with respect to reducing manufacturing costs.

Referring to FIG. 9G, a reflective layer 300 may be formed on the uneven layer 210′. The reflective layer 300 may be the same as the reflective layer 300 of FIG. 8B. According to example embodiments, by using the nano-imprint process, the reflective layer 300 having random heights may be formed at a relatively low cost and in a relatively simple manner.

FIGS. 10A and 10B are cross-sectional views of another method of manufacturing a reflective structure according to example embodiments. Referring to FIG. 10A, an underlayer 110 may be formed on a substrate 100. The underlayer 110 may be formed of a silicon oxide or another suitable material. The underlayer 110 may be regarded as part of the substrate 100. Formation of the underlayer 110 is optional. A plurality of nanoparticles 200 may be coated on the underlayer 110. The plurality of nanoparticles 200 may have non-uniform sizes and may form a mono-layer. Alternatively, the plurality of nanoparticles 200 may not form a mono-layer. Some of the plurality of nanoparticles 200 may contact each other and some may not.

Referring to FIG. 10B, the plurality of nanoparticles 200 and the exposed portions of the underlayer 110 between the plurality of nanoparticles 200 may be etched to form etched nanoparticles 200′ and an etched underlayer 110′. To etch the plurality of nanoparticles 200 and the underlayer 110, a reactive ion etching (RIE) method, an inductively coupled plasma-RIE (ICP-RIE) method, or other suitable dry etching methods may be used. In this regard, an etching gas including O₂ and/or CF₄ may be used in the RIE method or the ICP-RIE method. The plurality of nanoparticles 200 and the underlayer 110 may be formed of the same material and, thus, may be simultaneously etched using the same process.

On the other hand, the plurality of nanoparticles 200 may be first etched to some extent by performing isotropic etching and then anisotropic etching may be performed on the underlayer 110 by using the etched nanoparticles 200′ as etching barriers. The isotropic etching with respect to the plurality of nanoparticles 200 may be performed using an O₂ gas, and the anisotropic etching with respect to the underlayer 110 may be performed using a gas including O₂ and CF₄. When the underlayer 110 is etched, the plurality of nanoparticles 200 may also be etched. Etching with respect to the plurality of nanoparticles 200 and the underlayer 110 may be performed several times. The etched underlayer 110′ may have concaves and convexes, which are not uniform. Because the plurality of nanoparticles 200 have non-uniform sizes, the concaves and convexes having non-uniform sizes and shapes may be formed with relative ease in the underlayer 110.

Although not illustrated in the drawings, a reflective layer (e.g., reflective layer 300 of FIG. 8B) may be formed on the etched underlayer 110′ or on the etched underlayer 110′ and the plurality of etched nanoparticles 200′ (the etched nanoparticles 200′ may or may not be removed). In this manner, an omni-directional reflective structure may be manufactured.

In addition, after removing the plurality of etched nanoparticles 200′ of FIG. 10B, another plurality of nanoparticles may be coated on the etched underlayer 110′, and the underlayer 110′ may be etched again. An average size of the other plurality of nanoparticles may be equal to or different from that of the plurality of nanoparticles 200 of FIG. 10A. After further etching the underlayer 110′ one or more times, a reflective layer may be formed on the further etched underlayer.

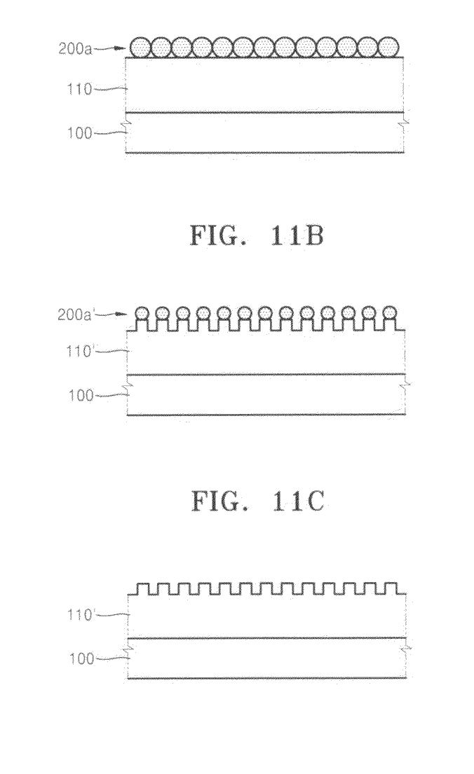

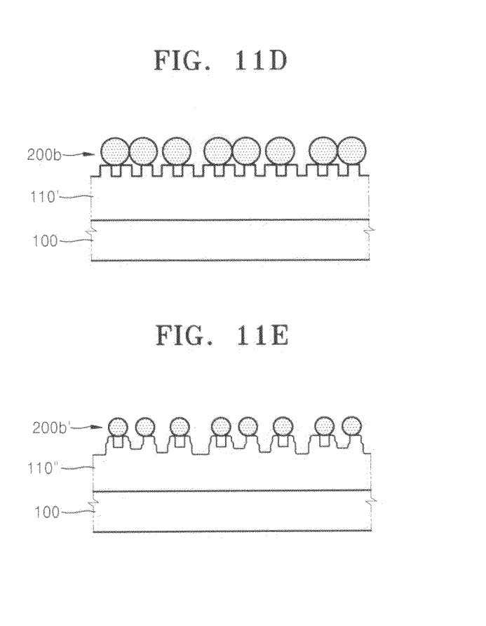

FIGS. 11A through 11E are cross-sectional views of another method of manufacturing a reflective structure according to example embodiments. Referring to FIG. 11A, after an underlayer 110 may be formed on a substrate 100, a plurality of first nanoparticles 200a having a uniform size may be coated on the underlayer 110. The underlayer 110 may be regarded as part of the substrate 100. Alternatively, the underlayer 110 may be omitted.

Referring to FIG. 11B, the plurality of first nanoparticles 200a may be initially etched and the exposed underlayer 110 between the plurality of etched first nanoparticles 200a′ may be subsequently etched to a predetermined depth. Etching with respect to the plurality of first nanoparticles 200a and the underlayer 110 may be similar to that with respect to the plurality of nanoparticles 200 and the underlayer 110 described with reference to FIG. 10B. The plurality of first nanoparticles 200a and the underlayer 110 may be formed of the same material and, thus, may be simultaneously etched using the same process.

On the other hand, the plurality of first nanoparticles 200a may be first etched to some extent by performing isotropic etching and then anisotropic etching may be performed on the underlayer 110 by using the plurality of etched first nanoparticles 200a′ as etching barriers. The isotropic etching with respect to the plurality of first nanoparticles 200a may be performed using an O₂ gas, and the anisotropic etching with respect to the underlayer 110 may be performed using a gas including O₂ and CF₄. Because the plurality of first nanoparticles 200a have a uniform size, concaves and convexes having relatively uniform sizes may be formed in the etched underlayer 110′.

Referring to FIG. 11C, the plurality of etched first nanoparticles 200a′ may be removed. Although not illustrated in the drawings, an additional underlayer may be further deposited in a conformal manner on the etched underlayer 110′ of FIG. 11C.

Referring to FIG. 11D, a plurality of second nanoparticles 200b may be formed on the etched underlayer 110′. The plurality of second nanoparticles 200b may have a uniform size which is different from the size of the plurality of first nanoparticles 200a of FIG. 11A. Referring to FIGS. 11A and 11D, the size of the plurality of second nanoparticles 200b may be greater than the size of the plurality of first nanoparticles 200a (although, in the alternative, the size of the plurality of second nanoparticles 200b may be smaller than the size of the plurality of first nanoparticles 200a). Because the plurality of second nanoparticles 200b are disposed on the concaves and convexes formed in the etched underlayer 110′, the positions of the plurality of second nanoparticles 200b may be controlled to some extent. As a result, some of the plurality of second nanoparticles 200b may be separated from each other.

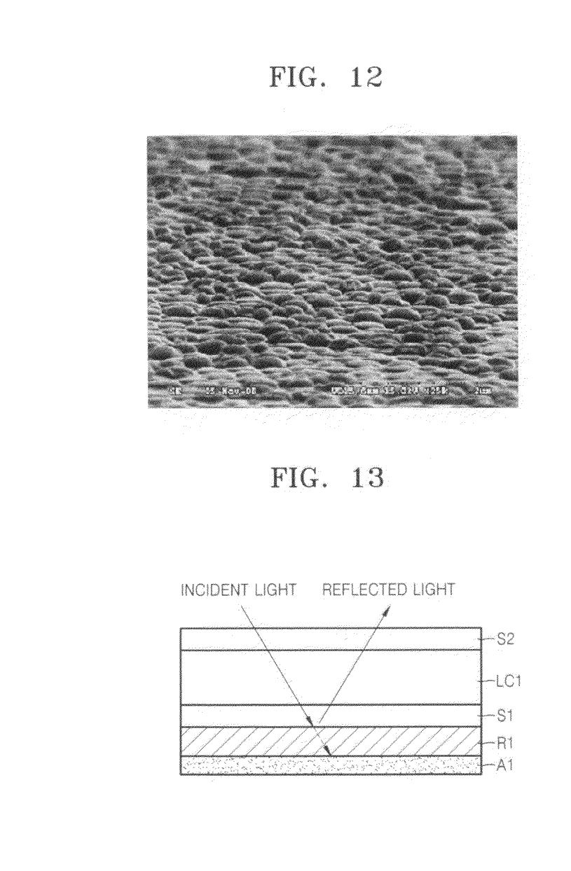

Referring to FIG. 11E, the plurality of second nanoparticles 200b and the exposed underlayer 110′ between the plurality of second nanoparticles 200b may be etched to form a plurality of etched second nanoparticles 200b′ and an etched underlayer 110′. Etching with respect to the plurality of second nanoparticles 200b and the underlayer 110′ may be similar to that with respect to the plurality of first nanoparticles 200a and the underlayer 110 described with reference to FIG. 11B. Although not illustrated, the plurality of etched second nanoparticles 200b′ may be removed, and the underlayer 110″ may be etched again using another plurality of nanoparticles. Thus, by etching the underlayer 110, an uneven surface may be formed. FIG. 12 illustrates a substrate (e.g., underlayer 110″ of FIG. 11E) which was formed with a method according to example embodiments. Referring to FIG. 12, the substrate (e.g., underlayer 110″ of FIG. 11E) has an uneven surface.

Although not illustrated in the drawings, a reflective layer (e.g., reflective layer 300 of FIG. 8B) may be formed on the etched underlayer 110″ or on the etched underlayer 110″ and the plurality of etched second nanoparticles 200b′ (the etched second nanoparticles 200b′ may or may not be removed). In this manner, an omni-directional reflective structure may be manufactured.

As shown in FIGS. 10A and 10B, and FIGS. 11A through 11E, by etching the underlayer/substrate while using a plurality of nanoparticles as etching barriers, an uneven surface may be formed with relative ease in the underlayer/substrate. As a result, a reflective structure including a reflective layer having random/varying heights may be formed with relative ease. In addition, after the uneven surface is formed in the underlayer or substrate using one of the methods according to FIGS. 10A-10B and FIGS. 11A-11E, a master stamp similar to the master stamp 250′ of FIG. 9C may be made by using the uneven surface. As a result, the master stamp may be used in a nano-imprint process.

The reflective structure and the method of manufacturing the reflective structure according to example embodiments may be applied to various display apparatuses. For example, the reflective structure may be applied to a dynamic device (e.g., liquid crystal display (LCD)) or to a static information providing medium (e.g., signboard). Also, the reflective structure may be applied to pigments (e.g., paint) or to cosmetics.

The reflective structure according to example embodiments may be substituted for a color filter of an LCD. A conventional absorption-type color filter has a relatively low transmittance and chromaticity, but a relatively high transmittance and chromaticity may be possible via the reflective structure according to example embodiments. In the case where the reflective structure according to example embodiments is applied to pigments or cosmetics, the reflective structure may be cut into relatively small sizes and mixed with the pigments or cosmetics. As a result, colors, which are difficult to realize using general pigments, may be attained.

FIG. 13 is a cross-sectional view of a liquid crystal display (LCD) to which a reflective structure according to example embodiments is applied. Referring to FIG. 13, a liquid crystal layer LC1 may be arranged between a lower substrate S1 and an upper substrate S2. A color reflector R1 may be arranged under the lower substrate S1. Alternatively, the color reflector R1 may be arranged between the lower substrate S1 and the liquid crystal layer LC1, instead of being arranged under the lower substrate S1. The color reflector R1 may be a reflective structure according to example embodiments. Although not illustrated in FIG. 13, the color reflector R1 may include a red reflecting region, a green reflecting region, and a blue reflecting region. When first through third reflective layers are formed in different regions of a substrate, by varying thicknesses and/or materials with respect to layers for forming the first through third reflective layers, the first through third reflective layers may reflect different colors. Thus, the first through third reflective layers may respectively correspond to the red reflecting region, the green reflecting region, and the blue reflecting region.

An absorption layer A1 may be further arranged under the color reflector R1. The absorption layer A1 may function to absorb light which is not reflected by the color reflector R1, that is, the light passing through the color reflector R1. For example, in the red reflecting region of the color reflector R1, light that exhibits a color other than a red color may pass through the color reflector R1 and then may be absorbed by the absorption layer A1. This absorption layer A1 is optional. Also, a substrate or nanoparticles of the color reflector R1 may be used as an absorbing component. According to other embodiments, the nanoparticles of the color reflector R1 may be coated with a predetermined color.

In addition, properties of the layers forming the reflective layer of the reflective structure according to example embodiments may change in response to a physical force. To be more specific, refractive indexes or thicknesses of the layers (dielectric layers or non-dielectric layers) forming the reflective layer may change in response to electric force or heat. In this case, by applying a suitable physical force (e.g., electric force or heat) to the reflective layer, it is possible to control or change the colors realized in the reflective layer. Therefore, a reflective structure according to example embodiments may be color controllable and/or color changeable. By using the reflective structure, it is possible to attain a reflective display apparatus that does not require a liquid crystal layer for controlling colors.

While example embodiments have been disclosed herein, it should be understood that other variations may be possible. Such variations are not to be regarded as a departure from the spirit and scope of example embodiments of the present application, and all such modifications as would be obvious to one skilled in the art are intended to be included within the scope of the following claims.

What is claimed is:

1. A reflective structure comprising:
an understructure having a first uneven surface, the understructure being a plurality of nanoparticles of non-uniform size on a substrate or being a sublayer having a non-uniform surface equivalent to surfaces of the plurality of nanoparticles; and
a reflective layer on the understructure, the reflective layer having a second uneven surface.

2. The reflective structure of claim 1, wherein the reflective layer includes at least one first layer and at least one second layer, the first and second layers being alternately stacked.

3. The reflective structure of claim 2, wherein the first layer and the second layer are different dielectric layers, or
wherein one of the first layer and the second layer is a dielectric layer, and the other one of the first layer and the second layer is a non-dielectric layer.

4. The reflective structure of claim 3, wherein the non-dielectric layer is a metal layer.

5. A reflective structure comprising:
an understructure having a first uneven surface; and
a reflective layer on the first uneven surface of the understructure, the reflective layer having a second uneven surface, and
wherein the reflective layer includes at least one non-dielectric layer and at least one dielectric layer, the non-dielectric layer and the dielectric layer being alternately stacked.

6. The reflective structure of claim 5, wherein the non-dielectric layer is a metal layer.

7. A display apparatus comprising the reflective structure of claim 1.

8. The display apparatus of claim 7, wherein the reflective layer includes at least one first layer and at least one second layer, the first and second layers being alternately stacked.

9. The display apparatus of claim 8, wherein the first layer and the second layer are different dielectric layers, or
wherein one of the first layer and the second layer is a dielectric layer, and the other one of the first layer and the second layer is a non-dielectric layer.

10. The display apparatus of claim 9, wherein the non-dielectric layer is a metal layer.

11. A display apparatus comprising the reflective structure of claim 5.

12. A method of manufacturing a reflective structure, comprising:
coating a substrate with a plurality of nanoparticles of non-uniform size; and
forming a reflective layer on the plurality of nanoparticles, the reflective layer having an uneven surface that corresponds to a contour of the plurality of nanoparticles.

13. The method of claim 12, wherein the reflective layer includes at least one first layer and at least one second layer, the first and second layers being alternately stacked.

14. The method of claim 13, wherein the first layer and the second layer are different dielectric layers, or
wherein one of the first layer and the second layer is a dielectric layer, and the other one of the first layer and the second layer is a non-dielectric layer.

15. The method of claim 14, wherein the non-dielectric layer is a metal layer.

16. A method of manufacturing a reflective structure, comprising:
coating a supporting material with a plurality of nanoparticles of non-uniform size;
forming a mold layer covering the plurality of nanoparticles;
separating the mold layer from the supporting material to attain a master stamp having an under surface that corresponds to a contour of the plurality of nanoparticles;
forming a first uneven surface on a substrate by imprinting the substrate with the master stamp; and
forming a reflective layer covering the first uneven surface, the reflective layer having a second uneven surface that corresponds to a contour of the first uneven surface.

17. The method of claim 16, wherein the reflective layer includes at least one first layer and at least one second layer, the first and second layers being alternately stacked.

18. The method of claim 17, wherein the first layer and the second layer are different dielectric layers, or
wherein one of the first layer and the second layer is a dielectric layer, and the other one of the first layer and the second layer is a non-dielectric layer.

19. The method of claim 18, wherein the non-dielectric layer is a metal layer.

20. A method of manufacturing a reflective structure, comprising:
coating a substrate with a plurality of first nanoparticles;
etching the plurality of first nanoparticles and exposed portions of the substrate between the plurality of first nanoparticles to form an etched substrate having a first uneven surface; and
forming a reflective layer on the etched substrate, the reflective layer having a second uneven surface that corresponds to a contour of the first uneven surface.

21. The method of claim 20, wherein the plurality of first nanoparticles are of non-uniform size.

22. The method of claim 20, wherein the plurality of first nanoparticles are of uniform size.

23. The method of claim 20, wherein forming the etched substrate having the first uneven surface includes:
initially etching the plurality of first nanoparticles to expose portions of the substrate between the plurality of first nanoparticles: and
etching the exposed portions of the substrate.

24. The method of claim 20, wherein forming the etched substrate having the first uneven surface includes simultaneously etching the plurality of first nanoparticles and the exposed portions of the substrate between the plurality of first nanoparticles.

25. The method of claim 20, further comprising:
removing the plurality of first nanoparticles after forming the etched substrate having the first uneven surface.

26. The method of claim 25, further comprising:
coating the substrate with a plurality of second nanoparticles after removing the plurality of first nanoparticles; and
etching the plurality of second nanoparticles and exposed portions of the substrate between the plurality of second nanoparticles.

27. The method of claim 20, wherein the reflective layer includes at least one first layer and at least one second layer, the first and second layers being alternately stacked.

28. The method of claim 27, wherein the first layer and the second layer are different dielectric layers, or
wherein one of the first layer and the second layer is a dielectric layer, and the other one of the first layer and the second layer is a non-dielectric layer.

29. The method of claim 28, wherein the non-dielectric layer is a metal layer.
